(19) United States
(12) Patent Application Publication
(10) Pub. No.: US 2005/0256737 A1
(43) Pub. Date: Nov. 17, 2005

(54) System and method for facilitating meetings between pharmaceutical sales representatives and physicians

(76) Inventor: Hsaio-Feng D. Liu, Jacksonville, FL (US)

Correspondence Address: Mark J. Young;Suite 227, 9951 Atlantic Blvd., Jacksonville, FL, 32225, US

(21) Appl. No.: 10/847,408

(22) Filed: May 17, 2004

(51) Int. Cl. G06F 17/60

(52) U.S. Cl. 705/2

(57) ABSTRACT

A networked system for facilitating meetings between pharmaceutical sales representatives includes a registration module configured to enable registration by subscribers. Subscribers may include one or more pharmaceutical sales representatives, medical professionals and caterers (also referred to herein as restaurants, irrespective of whether or not they deliver food). The system also includes a scheduling module configured to enable subscribing pharmaceutical sales representatives schedule meetings with subscribing medical professionals and to provide reminders of scheduled meetings. Additionally, the system includes a restaurant module configured to enable subscribing pharmaceutical sales representatives to place orders with subscribing caterers and render payment. Reporting functions generate receipts, reports of transactions and expense reports.

### FIELD OF THE INVENTION

This invention generally relates to a networked system for facilitating meetings between pharmaceutical sales representatives and physicians, and more particularly, to an Internet-based system which enables online scheduling of meetings, food ordering and setting of preferences.

### BACKGROUND

Pharmaceutical companies employ sales representatives to promote their pharmaceutical products. Sales representatives (“representatives”) often provide breakfast, lunch or dinner or other similar perks to entice physicians into a brief meeting. Such mealtime meetings have become the norm, and are expected by physicians and their staff. During such meetings, representatives supply physicians and/or their staff with food, as well as information, materials and samples of drugs.

Due to their hectic schedules, physicians often reluctantly meet with representatives. Despite their reluctance, most physicians will occasionally accommodate a brief mealtime meeting, typically at their office, to get helpful information, materials and samples. However, physicians do not want to meet with representatives with whom they are not familiar, or representatives promoting products of no interest. Physicians also avoid meetings that do not accommodate their preferences, such as the preferred times and days and types of food.

As a result, it is often difficult for representatives to efficiently schedule meaningful meetings with physicians. Not only must representatives be prepared to deliver the information, materials and samples during a short meeting, but they must meet the physicians' mealtime expectations while sticking to a budget. In addition to scheduling a meeting on a mutually acceptable date and time, a representative must arrange for lunch to be prepared and delivered for the physician and his/her staff. The representative will need to know the number of people to be served lunch, any preferences, and a local restaurant that can cater the meal within an acceptable price range. The representative must also contact the restaurant and make necessary arrangements for timely preparation and delivery of food and payment for the food. Furthermore, the representative must manage receipts to ensure proper expense reporting and reimbursement of expenses incurred.

Unfortunately, the various parties perform these various tasks without the aid of a system that integrates the information and facilitates the tasks necessary to arrange and conduct successful meetings. Caterers have no easy way of promoting their services to representatives. Doctors have no easy way of making their interests and preferences known to representatives. Doctors also have no easy way of checking the credentials of representatives. Representatives have no easy way of scheduling with doctors, making suitable meal arrangements, paying for food and managing receipts and expense reimbursement.

The invention is directed to overcoming one or more of the problems as set forth above.

### SUMMARY OF THE INVENTION

To achieve one or more of the problems set forth above, in an exemplary implementation of the invention, a networked system for facilitating meetings between pharmaceutical sales representatives is provided. The exemplary system includes a registration module configured to enable registration by subscribers. Subscribers may include one or more pharmaceutical sales representatives, medical professionals and caterers (also referred to herein as restaurants, irrespective of whether or not they deliver food). The exemplary system also includes a scheduling module configured to enable subscribing pharmaceutical sales representatives schedule meetings with subscribing medical professionals. Additionally, the exemplary system includes a restaurant module configured to enable subscribing pharmaceutical sales representatives to place orders with subscribing caterers and render payment. Reporting functions may also be provided to generate receipts, reports of transactions and expense reports.

### BRIEF DESCRIPTION OF THE DRAWINGS

The foregoing and other objects, aspects and advantages will be better understood from the following detailed description of an embodiment of the invention with reference to the drawings, in which:

FIG. 1 shows a high-level block diagram of a computer network upon which an exemplary implementation of the invention may be implemented;

FIG. 2 shows a high level block diagram of modules of a system in accordance with an exemplary implementation of the invention;

FIG. 3 is a flow diagram illustrating steps of a registration process in accordance with an exemplary implementation of the invention;

FIG. 4 is a flow diagram illustrating steps of an account management process in accordance with an exemplary implementation of the invention;

FIG. 5 is a flow diagram illustrating steps of a scheduling process in accordance with an exemplary implementation of the invention;

FIG. 6 is a flow diagram illustrating steps of a restaurant related process in accordance with an exemplary implementation of the invention;

FIG. 7 shows a pharmaceutical representative's user interface for a system in accordance with an exemplary implementation of the invention; and

FIG. 8 shows a web physician's user interface for a system in accordance with an exemplary implementation of the invention.

### DETAILED DESCRIPTION

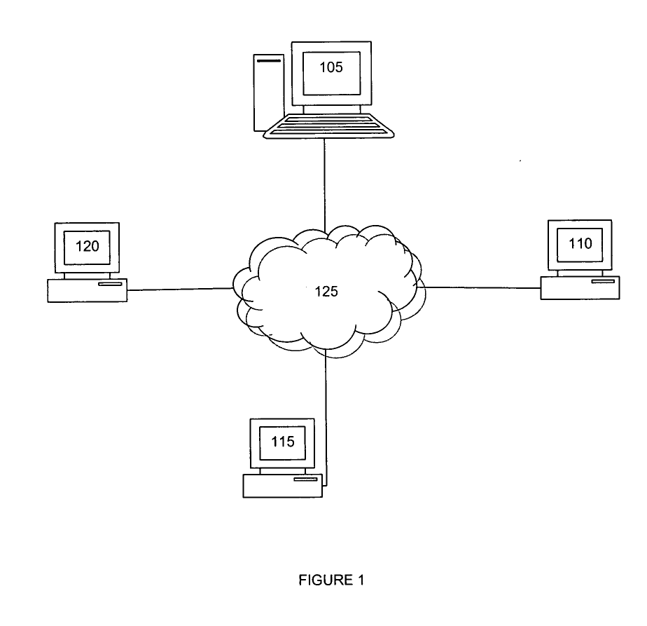

Referring to FIG. 1, a high-level block diagram of an online system in accordance with an exemplary implementation of the invention is shown. A server 105 hosts software for storing data and performing functions. Subscribers (e.g., physicians, representatives and caterers) using computing devices 110, 115 and 120 access the server 105 to perform various functions, such as registering, managing their schedules, updating information pertaining to them, and performing transactions. Subscribers may include representatives, physicians and restaurants. Access between the plurality of subscribers 110, 115 and 120 and the server 105 is preferably via data communications networks, which may include the Internet 125.

An exemplary server 105 is comprised of a computer system, having a bus for communicating information, a central processing unit (CPU), a read only memory (ROM), a random access memory (RAM), a mass storage device, and communications equipment. The storage device may include a hard disk, CD-ROM drive, DVD drive, tape drive, memory (e.g., RAM, ROM, Compact Flash RAM, PCMCIA RAM) and/or other storage equipment. An input device such as a keyboard, touch sensitive screen, a pointing device (e.g., a computer mouse, touch pad or joystick) and the like may also be provided. Software such as network operating system software is stored on and executable on the server 105.

These elements are typically included in many computer servers. Indeed, the aforementioned server 105 is intended to represent a broad category of computer systems capable of functioning as a computer server and hosting point application software for network access and use by subscribers in accordance with the present invention. Of course, the server 105 may include fewer, different and/or additional elements, functioning as a single server or as a distributed system, provided it is capable of performing the aforementioned functions in accordance with the present invention.

The server 105 also includes information, documents and software needed to provide functionally and enable performance of methodologies in accordance with an exemplary embodiment of the invention. For example, the server 105 may include web page information and documents (e.g., HTML and XML code), applets and application software, which manage subscriber access and use, processes transactions and manage databases for subscriber data.

A plurality of subscribers may access the server 105 using compatible computing devices 110-120 with network connectivity. By way of example, such devices 110-120 may include personal computers, personal digital assistants or any similarly equipped electronic computing devices.

Advantageously, the system provides a low cost of entry and short setup time for subscribers. It eliminates the need for each subscriber to have and maintain a specialized information technology infrastructure with a costly and complex application software, network operating system and database management software. It reduces or eliminates the need for costly information technology staff.

Additionally, the system provides a vehicle for combining purchasing power for the overall benefit of each individual representative. Demand can be aggregated across multiple representatives. The aggregated demand may help secure discounts for catering services. Subscribing representatives may procure services at reduced prices that result from higher purchasing volumes. Thus, the model strengthens the purchasing power of representatives.

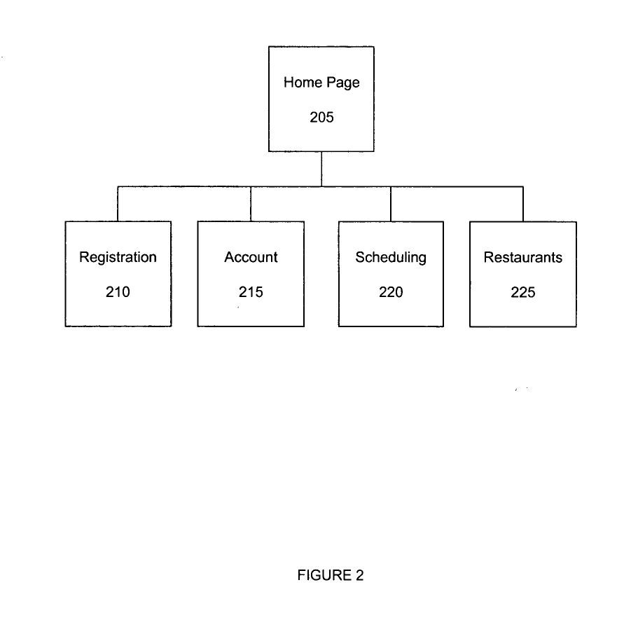

Referring now to FIG. 2, a block diagram of the application software implemented on the server 105 is provided. The application software may include web page information and documents (e.g., HTML and XML code), applets and application software and other executable code, configured to manage subscriber access and use, processes transactions and manage databases for subscriber data. The software may be conceptually divided into modules. A home page 205 provides user access to various modules, such as registration 210, account management 215, scheduling 220, and restaurant modules. Access may be provided via hyperlinks or other web-based features for facilitating access.

The registration module 210 is used to collect subscriber information and enroll subscribers. Requested subscriber information may vary according to the particular type of subscriber. The information may include identification information (e.g., name, address, telephone numbers, email address, etc . . . ) and payment information, such as credit card information for paying subscribers. For representatives, the information may also include a pharmaceutical company, a territory, and the type and brand name of pharmaceutical products marketed by the representative. For restaurants (i.e., caterers), the information may also include the type of food served, the geographic area (e.g., via zip codes) in which the restaurant provides delivery, and a detailed menu. For physicians, the information may also include the office manager's name, the size of the practice, the type of practice, any preferred days and times for meetings, types and/or brand names of pharmaceutical products of interest, and names of samples currently carried by the physician. The registration module may also request information needed to verify the credentials of a subscriber. For example, the module may request a drug representative's employer information for independent verification of the representative's employment and authority to promote the identified pharmaceutical products in the territory.

Enrollment entails establishing an account and granting permissions for a subscriber. Each account may be associated with a login. The permissions may depend upon the type of account (e.g., a trial or free account versus a paid account) and the type of subscriber. By way of example, only restaurants can post menus to the system, only a physician (or a person acting on behalf of a physician) may change the physician's information. Enrollment may also include storing subscriber information and processing any initial credit or debit card payments.

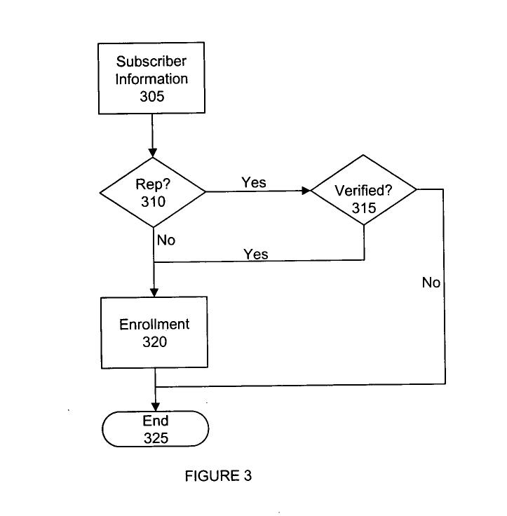

Referring now to FIG. 3, a high-level flowchart of an exemplary registration process is provided. In step 305 subscriber information is gathered. If the subscriber is a representative 310, the subscriber's credentials may be verified, as in step 315. Next, if the representatives credentials are verified, the subscriber is enrolled, as in step 320. However, if the credentials are not verified, enrollment does not occur and the process ends. After completing registration, the subscriber may logout 325. Thereafter, the subscriber may log into and access the system and use all features within the scope of the subscriber's permission.

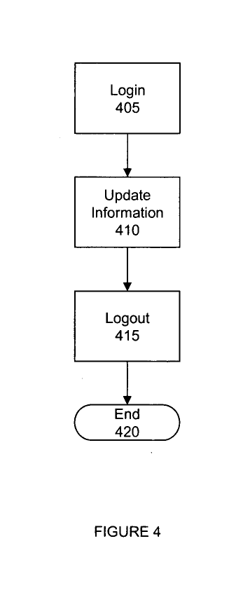

The account module 215 provides subscribers access to their account information and settings. Referring to FIG. 4, after logging into the system 405, a subscriber may access and manage account information 410, such as (for example) updating contact and payment information. A physician may also enter or update preferences, including an exclusion list of pharmaceutical representatives the physician will or will not see and pharmaceutical products the physician will or will not consider, the size of the physician's staff, meeting preferences (e.g., days, times, frequencies and meal preferences). A caterer may also update delivery information and menus, including prices. A pharmaceutical representative may also update his or her assigned pharmaceutical products and territories. Upon completing any updates, the subscriber may logout 415. Thereafter, the system will use the updated information.

The account module may also provide access to third parties or other subscribers, such as pharmaceutical companies, as appropriate. Pharmaceutical companies may be deemed subscribers (or third party non-subscribers) with access to the accounts of its representatives. Thus, pharmaceutical companies may delete and add representatives as appropriate and have super-user access privileges to such accounts.

The scheduling module provides calendaring tools for subscribers. The calendar presents a plurality of time slots for scheduling events. An event may be a meeting between a representative and a physician, as well as preparation and delivery of a meal for a meeting between a representative and a physician. The scheduling module is in communication with and utilizes the account module. Thus, a subscriber's calendar conforms to the subscriber's account information. Thus, if a physician indicates that he or she is not receptive to meetings on Mondays, the physician's calendar will show Monday's as unavailable. The calendar may allow representatives to select one or more available time slots for which the representative qualifies. Only a registered representative who promotes pharmaceutical products of interest to a physician may schedule an appointment. The calendar may also be configured to allow for subscribers to automate scheduling of appointments on a periodic (e.g., monthly, bimonthly, quarterly, semiannual or annual) basis.

Each time slot may have an associated status, such as available, unavailable, scheduled, confirmed and completed. Available time slots are those that are available for scheduling an event. Unavailable time slots are those that the subscriber has indicated are unavailable for scheduling an event. Scheduled time slots are those that the subscriber has indicated as being available and that another qualified subscriber has properly selected for scheduling an event. Confirmed time slots are those for which participating subscribers have confirmed their commitment. In the event of cancellation, e.g., if a subscriber has indicted an inability or unwillingness to attend, the time slot may be reset as available (or unavailable) as commanded by the canceling subscriber. Completed time slots indicate an event has taken place. The system prevents overbooking. The system also facilitates trading time slots. Status indicators may be presented in textual and/or graphic formats.

The scheduling module may also include communication tools to greatly facilitate correspondence between subscribers. Each time a meeting is scheduled by a subscriber, a communication may be transmitted to the other subscriber, thereby giving the subscriber a meaningful opportunity to confirm or cancel. A representative may submit an email message to another representative relating to possibly trading a time slot with the other representative, or to a physician relating to a scheduled or prospective meting. A physician may direct a meeting request or inquiry to any or all representatives who market a particular type or brand name of drug, without even knowing the representatives' identity. Representatives, physicians and caterers may easily communicate to help ensure that a catered meal meets everyone's expectations. A physician may communicate with another physician who previously met with a representative or who previously had a meal catered by a certain restaurant to find out about the experience.

The scheduling module may also include reminder tools to help ensure that a scheduled event is not overlooked by a subscriber. The system may send to a subscriber one or more reminders of a scheduled event a determined amount of time (e.g., one or more days) before the scheduled event. The system may also be configured to require a subscriber to confirm continued availability for the scheduled event. The confirmation request may be automated or prompted by another subscriber. Reminders may be provided via email, text message, voice message, telefacsimile or any other medium of automated communication chosen by a subscriber.

The scheduling module may also include a synchronization tool. This tool may import scheduled event data into the subscriber's local scheduling software, such as Microsoft Corporation's Outlook® computer program or some other compatible scheduling program. The tool may be configured to automate periodic updates or to synchronize upon subscriber command.

The scheduling module may also provide searching tools. The searching tools facilitate identifying other subscribers and scheduling events. Searches may be based upon any non-private information input into a system by a subscriber. User-selectable filters may be provided to limit search results. For example, representatives may be able to search for all physicians in a representative's territory that have a certain type of practice, or interest in certain types of medications, or interest in a particular name brand medication. A new representative may use this tool to introduce himself/herself to subscribing physicians in the relevant locale. As another example, physicians may search for representatives who promote a certain type of drug, or a particular brand name drug within the physician's locale. Using this tool, a physician will not need to keep track of a representative's contact information. Additionally, as a local representative for a drug changes, the system may direct physician communications to the correct representative, provided that representatives (or the pharmaceutical companies they represent) maintain current information.

Search results may include links to subscriber information, calendars and communication tools (e.g., email authoring tools). Thus, a subscriber may view another subscriber's non-private information to learn about the subscriber, and non-private calendar entries to determine availability. For example, a representative may view a physician's and caterer's calendars and information, and a physician may view a representative's calendar.

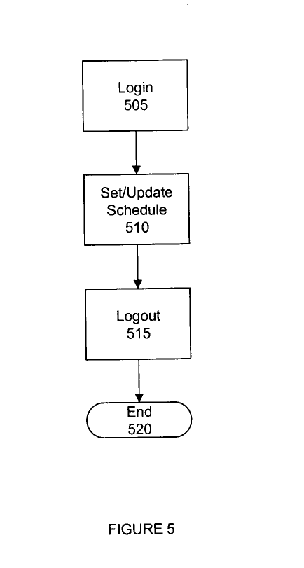

Referring now to FIG. 5, a high-level flowchart of a scheduling process in accordance with an exemplary embodiment of the invention is shown. After logging into the system 505, a subscriber may access and manage a schedule, including setting and updating information, such as a calendar configuration, calendar defaults and calendared events. The logged-in subscriber may also access and utilize the scheduling and calendaring functions and tools described above. Upon completing settings and updates and use of the functions and tools, the subscriber may logout 515. Thereafter, the system will use the updated schedule information.

Advantageously, an exemplary implementation of the invention includes a restaurant module 225 which provides information, functions and tools for subscribers to procure catering services and for restaurants to promote their services in a manner convenient for representatives. The restaurant module provides tools for searching, presenting menus, placing orders, rendering payment and managing transaction information.

Searching tools enable identification of restaurants in the general vicinity of a physician. The search may be based upon a street address or zip code of a physician's office. Additional search parameters (or filters) may include other relevant criteria, such as price ranges, type of cuisine and available days and hours of delivery. Subscribing restaurants may update their information using the account module. Restaurant searching tools may be accessed from links in various parts of the system. Using the tools, a subscriber may efficiently locate a restaurant suitable for catering a mealtime meeting.

The restaurant module may also include a menu presentation tool. Menus may be provided in a screen displayable format (e.g., HTML or XML) as well as in a printer-friendly format (e.g., Adobe Acrobat® portable document format [.pdf]). Subscribing restaurants may update their menus using the account module.

The restaurant module may also include an order processing tool. The order processing module receives order information, such as items, quantities, pickup or delivery dates and times, special instructions from a representative. The information may be entered using a template or online form. The system then associates the entered information with the representative and transmits it to the restaurant in a format and using a communication means acceptable to the restaurant. By way of example and not limitation, the system may communicate the order information to the restaurant via facsimile or email. The restaurant may be expected to confirm receipt and acceptance of the order online or via telephone touchtone encoder within a determined period of time or the order will be deemed rejected.

The restaurant module may also include a payment tool for processing payments for restaurant orders. A representative's credit card information may be stored as account information. With each placed order, a representative may have the choice of using the stored credit card information, or using another credit card. Credit card purchases may be processed in a conventional manner using a merchant account. Advantageously, the representative will not need to re-enter all of his/her default billing information for each transaction, as that information will be stored by the system's account module. The system may serve as a payment intermediary between the restaurant and the representative. Thus, payments received for restaurants (perhaps, less a commission and/or a transaction fee), may be credited to a restaurant's account of choice.

The restaurant module may also include a payment management tool for providing historical transaction information including, for example, receipts and, optionally, expense reports. Such information and materials may be provided automatically or upon request. A receipt will show all salient information relating to a purchase, including the identification of the physician for whom the purchase was made. An expense report will present expense information in an expense reimbursement form for signature by a representative. The system may also be configured to produce transaction reports for caterers, providing a summary of transactions over a period of time and the representatives for whom the transactions were made.

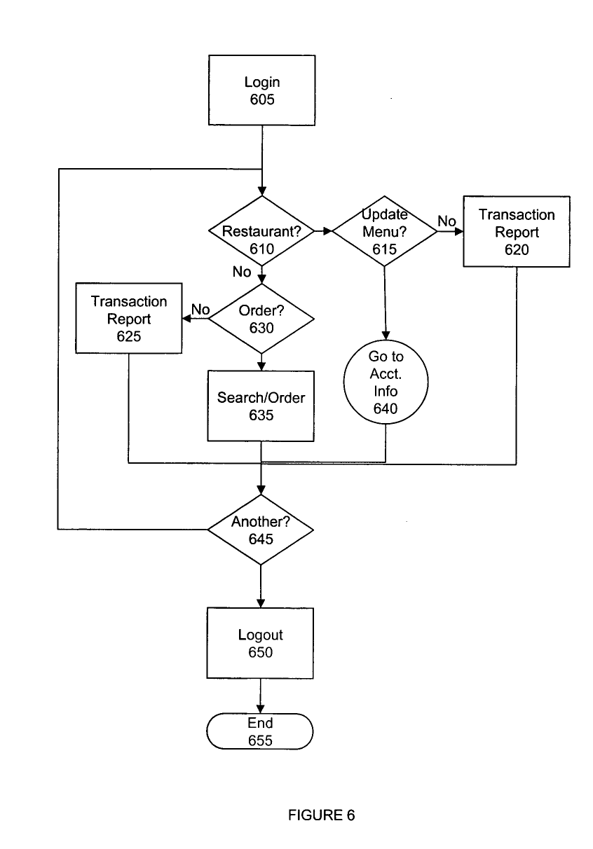

Referring now to FIG. 6, a high-level flowchart of a transaction management process in accordance with an exemplary embodiment of the invention is shown. After logging into the system 605, a subscriber may access and manage restaurant transaction information. If the subscriber is a restaurant (i.e., caterer) 610, then the subscriber may update its menu 615 or generate a transaction report 620 that shows food items purchased, payments received, a pharmaceutical sales representative for each purchase, when the food was prepared/delivered, and related information. If the subscriber is not a restaurant 630, then the subscriber may search for restaurants and place orders 635, or generate transaction reports, such as receipts and expense reports 625. Upon completing a task, the subscriber may perform another task 645 or logout 650.

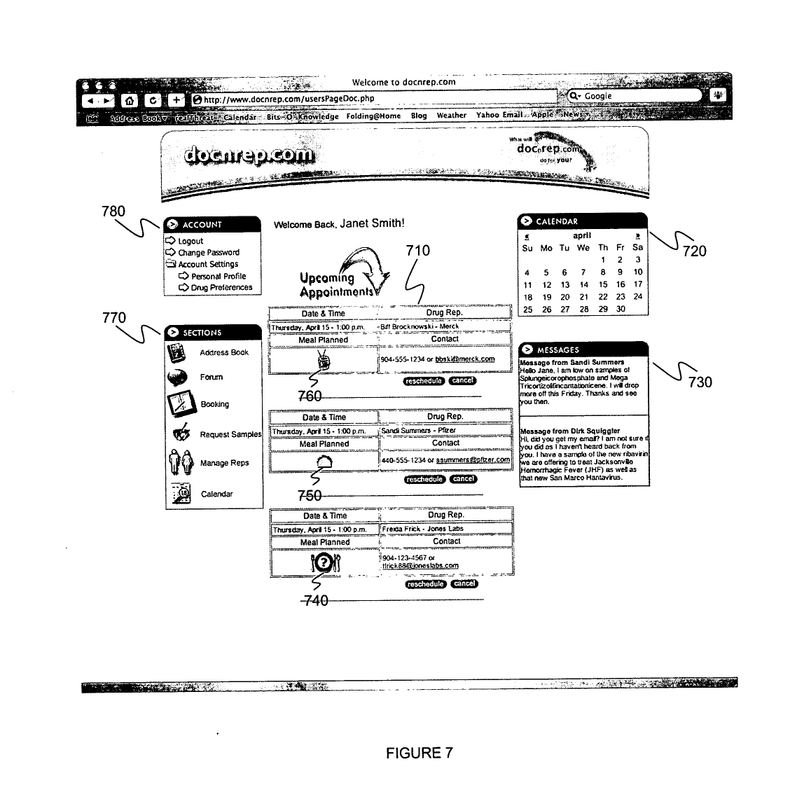

Referring now to FIG. 7, an exemplary physician's user interface for a system in accordance with an exemplary implementation of the invention is shown. The user interface may be implemented as an internet-accessible web page. After logging into the system, the physician may access the user interface to manage his/her schedule and perform various functions. Upcoming appointments 710 are shown chronologically. Each upcoming appointment identifies the date and time, the pharmaceutical representative, contact information for the pharmaceutical sales representative and meal information. If a meal is planned, the type of meal may be identified by a graphical icon. Thus, by way of example, graphical icons 750 and 760 display a taco and a Chinese takeout carton to identify Mexican food and Chinese food, respectively. Graphical icon 740 includes a question mark to signify that a meal has not been planned. Other indicia, including words and/or other graphical icons, may be used to convey information about the restaurant.

A calendar 720 facilitates access to appointments for a selected date. The calendar may be used to access past, current and future dates and appointment information. Dates may be distinctively highlighted on the calendar according to their status (e.g., appointment scheduled, no appointment scheduled, appointment tentatively scheduled, etc . . . ).

A message board 730 displays messages directed to the subscriber. An important aspect of the exemplary implementation of the invention is the ability to facilitate communication between and among subscribers. Using the system, a physician may efficiently communicate with a representative (and vice versa) without knowing the other's name, telephone number or email address. All contact information for subscribers may be stored by the system and used to facilitate communication. A subscriber may generate a new message and/or reply to existing messages by selecting the message link.

The sections box 770 provides access to various useful functions, including an address book for providing contact information for other subscribers. A forum link provides access to a chat/discussion group for subscribers to pose questions and share helpful information with other subscribers. A request samples link allows a physician to submit request for samples. Samples may be requested by brand name, generic equivalents, type of drug or symptom treated. Conveniently, the system will direct sample requests to the appropriate representatives. The physician need not keep track of the current representatives or their contact information. A booking link provides tools for creating a new appointment. A manage representatives link allows a physician to identify the types of representatives with which he/she may be interested in meeting. The representatives may be identified according to such categories as the type of drug promoted, the name brand of the drug promoted, the representative's pharmaceutical company, the name of the representative. A calendar link provides access to scheduling and calendaring tools as discussed above.

An account box 780 provides links to tools for managing a subscriber's account. A logout link enables a subscriber to logout, thereby concluding a session. A change password link enables a subscriber to manage his/her password. Account setting links include a personal profile link and a drug preferences link. The personal profile link enables a subscriber to manage its personal information, such as address and contact information, information about the type and size of the physician's practice, information about preferred dates and times for meeting, information about the type of food preferred, and any other information related to the physician's practice and meetings with representatives. A drug preferences link allows a physician to input information about the types of drugs of interest. For example, a physician may identify drugs according to such categories as types of drugs, brand names of drugs, generic versions of brand name drugs, and symptoms/afflictions treated by drugs.

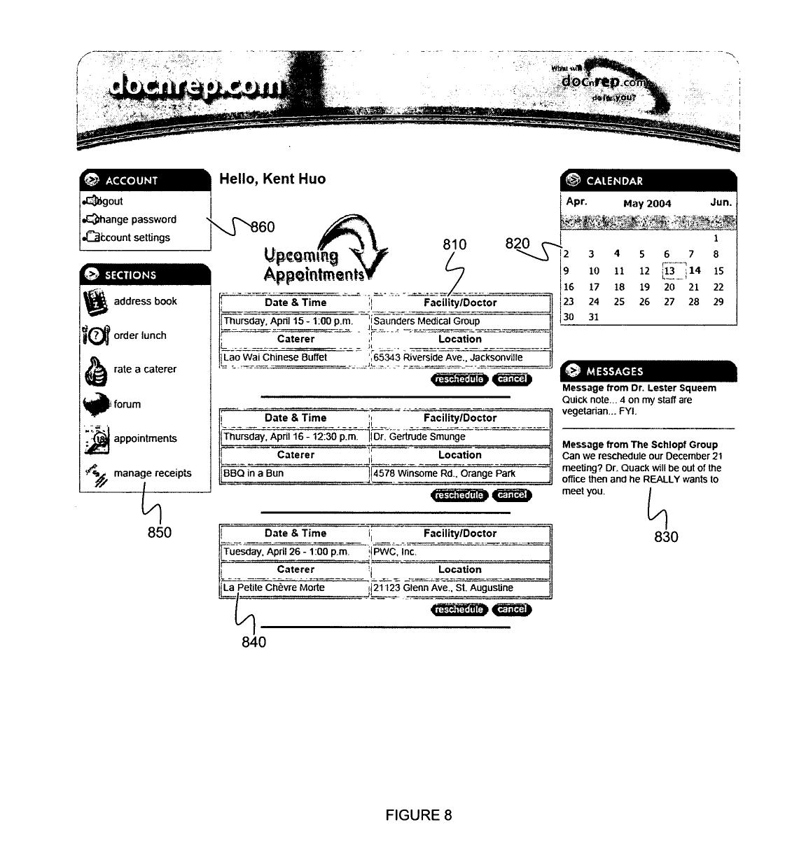

Referring now to FIG. 8, an exemplary representative's user interface for a system in accordance with an exemplary implementation of the invention is shown. The user interface may be implemented as an internet-accessible web page. After logging into the system, the representative may access the user interface to manage his/her schedule and perform various functions. Upcoming appointments 810 are shown chronologically. Each upcoming appointment identifies the date and time, the facility/physician, an address, and the caterer, e.g., 840. The type of meal may be identified by a graphical icon (not shown in FIG. 8).

A calendar 820 facilitates access to appointments for a selected date. The calendar may be used to access past, current and future dates and appointment information. Dates may be distinctively highlighted on the calendar according to their status (e.g., appointment scheduled, no appointment scheduled, appointment tentatively scheduled, etc . . . ).

A message board 830 displays messages directed to the subscriber. An important aspect of the exemplary implementation of the invention is the ability to facilitate communication between and among subscribers. Using the system, a physician may efficiently communicate with a representative (and vice versa) without knowing the other's name, telephone number or email address. All contact information for subscribers may be stored by the system and used to facilitate communication. A subscriber may generate a new message and/or reply to existing messages by selecting the message link.

The sections box 870 provides access to various useful functions, including an address book for providing contact information for other subscribers. An order lunch link provides access to a food ordering tool. Caterers available within a locale are provided. A representative may search and identify the available caterers by type of cuisine, average price per person per meal, ratings (e.g., ratings published by a third party or ratings according to subscribers) and other criteria. Representatives may pay for ordered food using the system. For example, credit card payments may be processed to pay the caterer. The system may be configured to store the representative's preferred credit card information, thus greatly simplifying the payment process. The system also tracks orders and payments, so that receipts and reports may be generated.

A rate a caterer link provides a tool for representatives to score caterers on the quality of their service. By way of example and not limitation, representatives may rate caterers according to the taste of the food, timeliness of the order, whether the food was appropriately hot when served, whether the order was correct, and overall satisfaction. This information will reward good caterers, provide an added incentive for good catering service and enable other subscribers to make intelligent catering decisions.

The sections box 850 includes links to other helpful tools. A forum link provides access to a chat/discussion group for subscribers to pose questions and share helpful information with other subscribers.

An appointment link provides access to an appointment tool. The appointment tool enables scheduling, confirming and changing appointments. Available physicians (i.e., physicians within the representative's territory) may be searched according to their drug interests and dates and times of availability. Physicians may set certain preferred dates and times in their preferences. The system will determine the days and times on which a physician already has and appointment. Representatives desiring to make an appointment may be prioritized according to preferences established by a physician, and/or on a first-come-first-served basis, and/or on some other priority establishing basis. Physicians may have an opportunity to accept or reject a meeting proposed by a representative. Confirmed (i.e., accepted) appointments will appear on the representative's upcoming appointments list.

A manage receipts link allows a physician to manage receipts. Available receipt management tools may include, by way of example, receipt generation; expense report generation; generation of reports of purchases by time period (e.g., month, quarter, etc . . . ), by physician or some other criteria. The receipt management tools may also be configured to produce expense reports in a format required by the representative's pharmaceutical company and transmit the reports automatically (or as commanded) to the representative and/or pharmaceutical company.

An account box 860 provides links to tools for managing a subscriber's account. A logout link enables a subscriber to logout, thereby concluding a session. A change password link enables a subscriber to manage his/her password. Account setting links enable a representative to enter personal information (e.g., name, address and contact information), identify and describe the type and brand names of drugs represented, identify the territory served, include links to helpful information for physicians' and patients, and input private information such as a credit card account number, expiration date and billing address for processing payments for food orders.

Those skilled in the art will appreciate that the terms module and tool are used for reference convenience to conceptually identify functions and groups of functions. The functions may be implemented using one or more software, firmware and/or hardware components, alone or in combination with other components without departing from the scope of the invention. Tools and modules may be arranged as described above or in a different manner without departing from the scope of the invention. Additionally, each component may implement one or more functions or parts of functions, in groupings as described above, or in different groupings without departing from the scope of the invention.

A system according to an exemplary implementation of the invention provides several revenue generating opportunities. Some or all subscribers may be charged subscription fees. Service charges may be assessed for processing food orders. Advertising fees may be charged for caterers and/or representatives to promote their goods and services. These and other fees and charges may be assessed to cover costs associated with implementing and managing the system and to make it a profitable enterprise.

While the invention has been described in terms of various embodiments and implementations, those skilled in the art will recognize that the invention can be practiced with modification within the spirit and scope of the appended claims.

1. A networked system for facilitating meetings between pharmaceutical sales representatives and physicians, said system comprising:
a registration module configured to enable registration by subscribers, said subscribers including one or more pharmaceutical sales representatives, medical professionals and caterers;
a scheduling module configured to enable subscribing pharmaceutical sales representatives to schedule meetings with subscribing medical professionals; and
a restaurant module configured to enable subscribing pharmaceutical sales representatives to place orders with subscribing caterers.

2. The system of claim 1, further comprising an account module configured to enable input of information pertaining to a subscriber.

3. The system of claim 2, wherein the information pertaining to a subscriber includes at least one of a subscribing physician's preferences, a subscribing physician's staff size, a subscribing restaurant's menu, an identification of a subscribing restaurant's geographic territory served, an identification of a subscribing representative's geographic trade territory, an identification of a subscribing representative's types of products represented, and an identification of a subscribing representative's brand names of products represented.

4. The system of claim 1, wherein the scheduling module includes a calendar tool configured to enable subscribers to enter events in a plurality of time slots.

5. The system of claim 4, wherein a time slot has a status, said status indicating whether the time slot is available for scheduling an event.

6. The system of claim 5, wherein the status of a time slot is one of available, unavailable or confirmed.

7. The system of claim 1, wherein the scheduling module includes a communication tool configured to enable communication of messages between subscribers.

8. The system of claim 7, wherein the communication tool is further configured to communicate messages to a subscriber using a communication medium selected by the subscriber.

9. The system of claim 8, wherein the communication medium includes one of electronic mail, text message, voice message, or telefacsimile.

10. The system of claim 1, wherein the scheduling module includes a reminder tool configured to communicate a reminder of a scheduled event to a subscriber.

11. The system of claim 10, wherein the reminder tool is further configured to communicate the reminder using a communication medium selected by the subscriber.

12. The system of claim 11, wherein the communication medium includes one of electronic mail, text message, voice message, or telefacsimile.

13. The system of claim 4, wherein the scheduling module includes a synchronization tool configured to synchronize an external electronic calendar of a subscriber with the calendar tool of the scheduling module.

14. The system of claim 1, wherein the scheduling module includes a searching tool configured to enable searching for subscribers.

15. The system of claim 1, wherein the restaurant module includes a searching tool configured to enable searching for subscribing restaurants.

16. The system of claim 1, wherein the restaurant module includes an ordering tool configured to enable online ordering.

17. The system of claim 17, wherein the restaurant module includes a payment tool configured to enable online payment processing for placed orders.

18. The system of claim 17, wherein the restaurant module includes a reporting tool configured to enable reporting of orders.

19. The system of claim 17, wherein the restaurant module includes a reporting tool configured to provide receipts for paid orders.

20. An Internet-based method of scheduling a meeting between a pharmaceutical sales representative and one or more physicians using an integrated website providing access to a registration module, a scheduling module and a restaurant module, said method comprising steps of:
registering the pharmaceutical sales representative and one or more physicians using the registration module;
scheduling at least one meeting between the registered pharmaceutical sales representative and the one or more physicians using the scheduling module; and
placing a food order with a caterer for the scheduled at least one meeting using the restaurant module.
